(19) United States
(12) Patent Application Publication
(10) Pub. No.: US 2017/0363864 A1
(43) Pub. Date: Dec. 21, 2017

(54) Dynamic Microscope with Combined Optical Focus and Aberrational Correction

(71) Applicant: H. Jay MARGOLIS, Centennial, CO (US)

(72) Inventor: H. Jay MARGOLIS, Centennial, CO (US)

(21) Appl. No.: 15/532,858

(22) PCT Filed: Nov. 24, 2015
(86) PCT No.: PCT/US2015/062405

§ 371 Date: Jun. 2, 2017

Related U.S. Application Data
(60) Provisional application No. 62/086,543, filed on Dec. 2, 2014.
(60) Provisional application No. 62/195,458, filed on Jul. 22, 2015.

(51) Int. Cl. G02B 27/00; G02B 7/28; G02B 15/06; G02B 21/02

(52) U.S. Cl. CPC G02B 27/0068; G02B 21/025; G02B 7/28; G02B 15/06

(57) ABSTRACT

The present invention provides microscopes and optical devices able to provide improved spherical aberration correction through the combined use a first optical system which comprises a common moveable or deformable rear lens system which forms part of the microscope objective in conjunction with a semi-objective lens system, and a second optical system which comprises a telescopic focusing system. Deforming, moving or repositioning one or more lenses of the common moveable or deformable rear lens system in the first optical system is able to act primarily on the anterior Gauss particulars (or the front conjugate) of the objective, while the telescopic focusing system of the second optical system is able to act on both the anterior and posterior Gauss particulars (or the front and rear conjugates). Adjustment of both optical systems in combination with one another allows for the formation of an improved image with enhanced spherical aberration correction.

### CROSS-REFERENCE TO RELATED APPLICATIONS

This application claims priority from U.S. Provisional Patent Application Nos. 62/086,543, filed Dec. 2, 2014, and 62/195,458, filed Jul. 22, 2015, both of which are incorporated by reference herein to the extent that there is no inconsistency with the present disclosure.

### BACKGROUND OF THE INVENTION

The present invention is in the field of microscopes and relates to the correction of spherical aberration through the combined use of two optical systems within the microscope device.

Spherical aberration is an optical defect that occurs when parallel rays of light passing through the central region of a lens focus at a different point across the optical axis than parallel rays of light passing through the edges or periphery of the lens. As a result, the rays of incoming light do not converge at the same point thereby affecting the resolution and clarity of the image. When rays passing through the periphery of the lens focus closer to the lens than rays passing through the central region, the lens is said to have negative spherical aberration. When rays passing through the periphery of the lens focus further from the lens than rays passing through the central region, the lens is said to have positive spherical aberration.

The problem of spherical aberration as caused by external influences on a microscope's optical system was determined independently as early as 1827 by Giovanni Amici and Joseph Jackson Lister. Andrew Ross, in acting upon Lister's criteria, determined circa 1837 that moving the lenses inside a microscope objective could reduce spherical aberration by operating on the anterior Gauss particulars, thus inventing the mechanical means known as the correction collar.

In current microscopes, high magnification objectives are typically designed to be used with space being present between the front lens and a cover glass covering the sample. Most objectives are also designed to be used with a standard cover glass thickness of 0.17 millimeters. However, when objectives with high numerical apertures are used, variations of just a few micrometers in the cover glass thickness can cause significant spherical aberration and image degradation. A correction collar which allows for adjustment of the positioning of a central lens group within the objective is often used to compensate for these errors. Correction collars can be used with objectives intended to be used in air or with water or glycerin immersion media.

The correction collar and similar variants have been among the most successful means of obtaining spherical correction. Aspheric surfaces may also be applied to reduce this defect. However, further improvement of spherical correction is required especially for high performance microscope devices. For instance, devices utilizing correction collars often require small changes to be made to the distance between the object and the microscope, such as lowering the microscope to be closer to the object, which may be limited due to space constraints or which may exert undesirable pressure on objects immersed in a liquid media. Furthermore, motorized correction collars are bulky and cannot be made to work easily on turrets or revolvers which allow successive objectives with motorized correction collars to be used for alternate purposes. Improved microscope systems and devices that provide enhanced correction of spherical aberration and flexibility are therefore highly desirable.

Margolis (U.S. Pat. No. 4,988,173) teaches the use of an a focal variator optical system which can be used in optical instruments, such as long-distance microscopes, as the mechanism for providing focus. An afocal variator has the ability to vary the actual focal length of a front optical system in conjunction with a rear optical system without the need to physically change the length dimension or the lens position or the lenses of the front optical system. In addition, the afocal variator can be utilized to provide a total optical device in which magnification change occasioned by focusing does not change within a reasonable functioning range. U.S. Pat. Nos. 5,452,133 and 7,869,139 (also by Margolis) similarly teach the use of a subsumed afocal variator for similar applications. Focusing systems derived from these afocal variators have been commercialized as InFocus™ and MID/CON™ (Motorized InFocus Device for Confocal Microscopy) and CentriTel®, all manufactured by Infinity Photo-Optical Corporation.

Other references known in the art, such as Benford, Rosenberger, Aklin, Ruben and Seidenberg, (U.S. Pat. Nos. 3,471,218; 3,476,462; 3,507,554; 3,481,665; 3,497,290; 3,515,463; 3,514,189; and 3,174,396), teach inter alia the use of a negative lens that is fixed in position to be common to microscope semi-objectives and which is designed to be used as the final lens forming de facto complete objectives. By so doing, a single rear negative element can provide c.5× further amplification of the magnification of semi-objectives designed to be used with it, thereby lessening the formula constraints on such objectives and allowing them to be made of larger diameter elements because the total symmetry of the system (i.e., the distance from the objective section of the total system to the negative element) is longer than typical objectives of other construction.

The present invention provides spherical aberration correction by utilizing an active spherical correction objective system which is interrelated with an active focusing system. As described further herein, certain embodiments of the present invention provide a semi-objective lens system along with a moveable or deformable rear common lens system, which operate primarily on the front conjugate of the objective (also generally referred to herein as the anterior Gauss particular), that can be combined with a telescopic focusing system or afocal variator lens systems, which operate on both the front and rear conjugate of the objective (also generally referred to herein as the anterior and posterior Gauss particulars). It is also an object of certain embodiments of the present invention to provide spherical aberration correction to infinity-corrected compound or compounded microscopes.

While the above noted references teach the separate use of afocal variators for optical focusing and microscope semi-objectives made with a fixed rear negative lens element for simplifying the construction of microscopes, they do not teach or suggest that spherical aberration could be significantly reduced through the combined use of an active focusing system (such as an afocal variator or subsumed afocal variator) in conjunction with a moveable or deformable common rear negative lens system used to form a complete microscope objective system and, further, by the articulation and movement of the negative lens system which forms the final objective lens system in common with other lens systems so as to constitute a microscope objective (or other type of objective) in toto. In fact, Benford and the other related references specifically and consistently state that such common rear lens system must be static and not dynamic and further do not teach the use of an afocal variator in conjunction with such rear systems.

It is now asserted that complete or near complete spherical correction of present-day microscopes can be achieved by the combination of the two distinct optical systems acting in harmony with one another as described herein.

### SUMMARY OF THE INVENTION

One aspect of the present invention provides microscopes and optical devices able to provide improved spherical aberration correction through the combined use of two different optical systems. The first optical system comprises a common moveable or deformable rear lens system which forms part of the microscope objective when combined with a semi-objective lens system, wherein moving, repositioning, or deforming the common moveable or deformable rear lens system is able to primarily alter the front conjugate (also referred to herein as the anterior Gauss particular) of the of the objective. The second optical system comprises a telescopic focusing system which is able to alter both the front conjugate and rear conjugate of the objective (also referred to herein as the anterior and posterior Gauss particulars). This means that little focus but significant aberrational correction is primarily accomplished by the semi-objective in combination with the common moveable or deformable rear lens system, while the second optical system primarily provides focus changes to both front and rear objective conjugates. Adjustment of both optical systems in combination with one another, such as by moving or deforming the common rear lens system and by actively focusing the telescopic focusing system, allows for the formation of an improved image with enhanced spherical aberration correction. In particular, the use of the common moveable or deformable rear lens system with a telescopic focusing system having an afocal variator allows for correction of spherical aberration while eliminating the need for additional mechanical focus which alters the distance between the object and the microscope.

The microscopes of the present invention include, but are not limited to, compound microscopes. In one aspect of the present invention, the microscope is an infinity corrected microscope wherein the objective produces an infinity beam or a beam that is near infinity. As used herein, an “infinity beam” refers to rays of light, or other types of electromagnetic radiation, travelling in a path which does not deviate by more than 5% from parallel, preferably no more than 1% from parallel, even more preferably no more than 0.1% from parallel.

A tube lens or telescopic focusing system able to receive the beam generated by the objective and able to focus to infinity is then used to produce the intermediate image. Auxiliary components (such as illuminators, polarizers, prisms, beam splitters, polarizers, etc.) can be added into the optical path of the infinity beam between the objective and the tube lens with only a minimal effect on focus.

In such systems, the same common moveable or deformable rear lens system can be used with different semi-objective lens systems, which can have different magnification power, so long as the resulting microscope objective is able to provide an infinity beam (or near infinity beam) to the telescopic focusing system. A complete microscope objective is formed only when the common moveable or deformable rear lens system is combined with an appropriate semi-objective lens system. Properties such as the magnification of the microscope objective can be altered simply by switching between different suitable semi-objective lens systems while allowing the other components of the microscope to remain unchanged. Thus, in addition to providing enhanced spherical aberration correction, the present invention further allows an entire series of semi-objectives to be calculated and manufactured to mate with the same common moveable or deformable rear lens system in order to result in the objective having the desired quality and properties. It is therefore an object of the present invention to provide multiple objectives or semi-objectives on a microscope with the ability to focus and correct spherical and other aberrations by means of a single base optical device compatible for all of the multiple objectives or semi-objectives. That is, unlike being specific to a single objective as a correction collared objective would be, the present invention permits the use of different objectives having various magnifications and specifications with the same device.

In the embodiments described herein, it is understood that the term “common moveable or deformable rear lens system” encompasses a common moveable rear lens system (i.e., a system where one or more lenses are able to move without any deformable lenses), a common deformable rear lens system (i.e., a system where one or more lenses are able to be deformed without any moveable lenses), and a common rear lens system which comprises one or more moveable lenses and one or more deformable lenses.

Thus, one embodiment of the present invention provides a common microscope device containing a specialized or proprietary common moveable rear lens system built into the microscope base, stand or frame while interchangeable semi-objective lens systems, each calculated to be compatible with the common moveable rear lens to form a functional objective, are provided separately. In another embodiment, a common microscope device is provided containing a specialized or proprietary common deformable rear lens built into the microscope frame or stand while interchangeable semi-objective lens systems, each calculated to be compatible with the common deformable rear lens to form a functional objective, are provided separately. A wide range of optical properties and configurations are therefore achievable for the same single base model microscope by selecting and attaching a different semi-objective lens system.

As used herein, the common moveable or deformable rear lens system can comprise a single lens or a combination of lenses, including but not limited to doublets and triplets as known in the art, as long as the combination of the semi-objective lens system and common moveable or deformable rear lens system is calculated to produce a functional microscope objective. In one embodiment, the position of one or more lenses of the common moveable or deformable rear lens system is adjustable so as to be able to be moved toward or away from the semi-objective. In a further embodiment, one or more lenses of the common moveable or deformable rear lens system remain in a fixed position (i.e., do not move) while one or more other lenses of the common moveable or deformable rear lens system are able to move toward and away from the semi-objective lens system so as to change the focal length of the common moveable or deformable rear lens system as a whole. For example, the common moveable or deformable rear lens system may comprise a moveable lens in front of or behind one or more non-moveable lenses, a central non-moveable lens surrounded by moveable lenses, or a central moveable lens which is surrounded by non-moveable lenses. In another embodiment, one or more lenses of the common moveable or deformable rear lens system are deformable wherein the deformation of the lens changes the focal length of the common moveable or deformable rear lens system as a whole. In embodiments where one or more lenses of the common moveable or deformable rear lens system are deformable, the position of the one or more lenses within the housing may be fixed or adjustable.

The combined optical systems can be used with motors and other means known in the art for moving lens systems within the device, selectively deforming lenses, and for activating focus in conjunction with controllers, algorithms, software or other computational methods so as to adjust each optical system in relation to each other to produce an optimized image.

One embodiment of the present invention provide a microscope comprising: a) an optical housing able to hold one or more optical lens systems; b) an objective lens system, wherein said objective lens system is disposed within the optical housing and comprises a semi-objective lens system and a common moveable or deformable rear lens system; and c) a focusable telescope optical system in optical series with the objective lens system, wherein said objective lens system is able to provide an infinity beam to the focusable telescope optical system and said focusable telescope optical system is able to receive said infinity beam and impart focal change to the objective lens system. In one embodiment, the common moveable or deformable rear lens system is a common moveable rear lens system. In another embodiment, the common moveable or deformable rear lens system is a deformable lens system.

In one aspect of the invention, the common moveable or deformable rear lens system is positioned between the semi-objective lens system and the focusable telescope optical system and comprises one or more lenses able to move towards and away from the semi-objective lens system so as to impart focal change to the front conjugate of the objective lens system. Alternatively, the common moveable or deformable rear lens system is positioned between the semi-objective lens system and the focusable telescope optical system and comprises one or more deformable lenses wherein selectively deforming the one or more lenses imparts focal change to the front conjugate of the objective lens system. In one embodiment, the common moveable or deformable rear lens system is a negative lens able to move towards and away from the semi-objective lens system, a deformable lens, or comprises multiple lens elements where one or more of the lens elements are deformable or are able to move towards and away from the semi-objective lens system. The objective lens system as a whole is able to provide an infinity beam to the focusable telescope optical system, wherein the focusable telescope optical system is able to receive and impart focal change to both the front conjugate and rear conjugate of the objective lens system.

The semi-objective lens systems used herein can be any semi-objective lens system or combination of semi-objective lens systems known in the art able to form a functional microscope objective when combined with the common moveable or deformable rear lens system. In one embodiment, the common moveable or deformable rear lens system comprises a negative lens while the semi-objective lens system comprises at least one positive lens system, an achromatic lens system, an apochromatic lens system, or any combination known in the art therefore. In a further optional embodiment, the semi-objective lens system is articulable and is able to be moved toward and away from the object so as to provide additional focusing means. In this embodiment, the semi-objective can be moved toward or away from the object in conjunction with movement of the common moveable or deformable rear lens system or independently of the common moveable or deformable rear lens system.

The common moveable or deformable rear lens system can be used with a wide range of different semi-objective lens systems to form complete objectives having varying properties, such as different magnification and/or working distances, as long as the semi-objective lens systems are calculated and constructed so as to form the desired objective taking into account the properties of the common moveable or deformable rear lens system. In this way, a wide variety of microscope devices can be provided by substituting different semi-objective lens systems while keeping the other elements of the microscope device, particularly the common moveable or deformable rear lens, the same. In a further embodiment, the formed objectives are compatible with current microscope optics and could be utilized in current microscope systems which do not utilize an additional telescopic focusing system as described herein.

In one embodiment, the microscope comprises a plurality of selectable semi-objective lens systems, wherein each selectable semi-objective lens system has a different magnification and sophistication of optical correction, construction or technique, and is able to form a functional microscope objective with the common moveable or deformable rear lens system. In a further embodiment, the common moveable or deformable rear lens is built within the frame or stand of the microscope while the microscope comprises a turret having a plurality of objective tubes, wherein each objective tube contains a selectable semi-objective lens system, and wherein the turret is able to be rotated so as to selectably align one of the selectable semi-objective systems with the common moveable or deformable rear lens system. Alternatively, the semi-objective lens system is removable and can be easily replaced with a different semi-objective lens system for various purposes, techniques and/or optical correction categories.

In another embodiment, the common moveable or deformable rear lens system and semi-objective lens system are provided as part of interchangeable modules which can be attached and removed from different microscopes. This allows different combinations of removable semi-objectives and common moveable or deformable rear lenses to be utilized with different microscope systems to allow a wide range of different microscope systems having improved spherical correction to be easily constructed.

The focusable telescope optical system can be any means of internal telescope focusing known in the field of microscopes. In one embodiment, any focusable telescope known in the art can be utilized to some extent or another, limited only by suitability and compatibility. Preferably, the focusable telescope optical system comprises an afocal variator or a subsumed afocal variator. In one embodiment, the focusable telescope optical system comprises an afocal variator comprising a first positive lens system, a central negative lens system, and a second positive lens system, wherein the central negative lens system is positioned between the first and second positive lens systems and is able to move towards and away from the first positive lens system and towards and away from the second positive lens system. In one embodiment, the focusable telescope optical system comprises an afocal variator comprising a first positive lens system, a central negative lens system, and a second positive lens system, wherein one or more of these lenses are deformable, wherein deforming one or more of the lenses results in a change of focus.

In a subsumed afocal variator, the magnification power of one or more lens systems of the optical device are subsumed or included in the power of one or more of the lens systems of the afocal variator. In the present invention, the afocal variator system is used telescopically to achieve a focus range. One benefit of such a system is that focus can be achieved without having to physically change the length of the housing or move the object, front lens or the microscope stand. Alternatively, the focusable telescope optical system comprises a first negative lens system, a central positive lens system, and a second negative lens system, wherein the central positive lens system is positioned between the first and second negative lens systems. In another embodiment, a series of lenses to shorten or expand the telescope optical system's focal length is provided.

The repositioning and/or deformation of the common moveable or deformable rear lens system and the adjustment of the focusing of the focusable telescope optical system can be controlled independently of one another; however, preferably both systems are controlled in conjunction with one another so that adjustment of one system will be accompanied by adjustment of the other system to provide a fine tuned image with reduced spherical aberration. For example, if the position of the common moveable or deformable lens is moved (such as to adjust the working distance of the objective), then the focus of the focusable telescope optical system will also be adjusted to take full advantage of the spherical correction properties of the device.

In one embodiment, the one or more lenses of the common moveable or deformable rear lens system is repositioned or deformed manually, and the focusable telescope optical system is focused manually. In another embodiment, the microscope device comprises means for moving or deforming the common moveable or deformable rear lens system, including but not limited to motors and servomechanisms, and means for focusing the focusable telescope optical system, including but not limited to a second motor or second servomechanism. In another embodiment, the common moveable or deformable rear lens system is articulated using vibrations by known means such as a voice coil, so that minute differences in the infinity beam can be varied with the resultant change in the focusable telescope also being informative and able to be processed. This would permit a corroborative comparison to be made between aberrated and non-aberrated data. In another embodiment, the common moveable or deformable rear lens system is able to be rotated, tilted and/or canted in addition to being able to move toward and away from the semi-objective lens system. The spinning, tilting and/or canting of the common moveable or deformable rear lens system can be controlled using means known in the art. The common moveable or deformable rear lens system can incorporate deliberate residual errors, for example coma and astigmatism, which can apply an opposite correction to residual errors in the semi-objective system. Moreover, by rotating, spinning or canting the common moveable or deformable rear lens system, these errors can be quantified as they are progressively controlled or induced. Rotation of a common moveable or deformable rear lens designed to do so, can for example, correct astigmatism retained in the semi-objective system either wittingly or unwittingly. This rotation can be either manual or motorized for use by the microscopist or fixed in a permanent position as a final adjustment in manufacture thereby reducing production costs.

Preferably, the microscope device further comprises a controller having a computer processor, wherein the controller is able to operate the means for repositioning or deforming the common moveable or deformable rear lens system and the means for focusing the focusable telescope optical system according to a software program or algorithm stored on said processor, wherein the controller moves or deforms the common moveable or deformable rear lens system in conjunction with focusing the focusable telescope optical system to provide a desired image according to parameters determined by the software program or algorithm.

In one embodiment, the common moveable or deformable rear lens system is moved or deformed in conjunction with adjusting the focus of the focusable telescope optical system while the microscope device takes multiple scans of varying depth through a sample, such as through the vertical direction (Z direction) of a sample. The controller analyzes the images from the multiple scans and searches for the optimal settings according to parameters determined by the software program or algorithm. For example, the controller will determine the focus of the focusable telescope optical system and the position of the common moveable or deformable rear lens system which provides the greatest contrast for the multiple scans of the sample. Preferably, this analysis can be performed in real time.

The controller may also comprise or be connected to one or more sensors or cameras able to detect contrast levels in an image generated by the microscope device, wherein the controller is able to adjust the focus of the focusable telescope optical system and/or move or deform the common moveable or deformable rear lens system in conjunction with focusing the focusable telescope optical system to provide a desired image as determined by the software program or algorithm. The present invention can be utilized with any means known in the art that can derive data for determining an optimal image, including but not limited to evaluating contrast, brightness, or intensity, in or more portions of the image. The controller can comprise a feedback mechanism wherein activation of either the common moveable or deformable rear lens system or the focusable telescope optical system causes a reciprocal activation of the other component. Alternatively or in addition, the cameras or sensors provide input to the controller allowing the software program or algorithm to activate the common moveable or deformable rear lens system and/or the focusable telescope optical system in response to the input from the cameras or sensors, even to enable maintenance of a specific focal power or the sweeping of alternative depths or any combination thereof.

In one embodiment, the present invention provides an image field that is usual in the field of microscopy so that conventional eyepieces can be used. In another embodiment, the present invention is able to provide an image field that is usual in the field of microscopy so that sensors and cameras typically used in microscopy can be used. It is another object of the present invention to provide an image field that, with amplifying optics typically used in microscopy (i.e., Barlow or Eyepiece Projection), can cover any and all formats heretofore established for use in the field of microscopy.

The lens systems described herein can each comprise a single lens or multiple lenses, such as doublets or triplets, as known in the art. In a further embodiment, the present invention further comprises one or more additional optical components, including but not limited to eye pieces, sensors, cameras, corrective lens systems, beam splitters, polarizers, prisms, illuminators and combinations thereof, to modify and produce the final image or images. The additional optical components may be used in conjunction with the objective lens system, the focusable telescope optical system, or placed along the optical path between the objective lens system and the focusable telescope optical system. Preferably, the additional one or more additional optical components are positioned in infinity space.

In one embodiment, the common moveable or deformable rear lens system comprises vacuum deposited material, polarizing material, holographic elements, diffraction patterns or refractive elements such as plano-aspheric plates. In a further embodiment, the objective contains a holographic element able to superimpose a holographic image over the image of the object formed by the microscope. The image formed by the holographic element can have a depth of focus in that altering the focus of the microscope will cause different portions of the holographic image to come into and out of focus. In a further embodiment, the formed holographic image contains markings, such as a size scale, that may aid an operator when using the microscope.

In one embodiment, the present invention provides a microscope comprising: a) an optical housing able to hold one or more optical lens systems; b) an objective lens system disposed within the optical housing having a front conjugate and a rear conjugate, wherein said objective lens system comprises a semi-objective lens system and a common moveable or deformable rear lens system, wherein one or more lenses of said common moveable or deformable rear lens system is able to be deformed or moved towards and away from the semi-objective lens system so as to impart focal change to the front conjugate of the objective lens system; and c) a focusable telescope optical system in optical series with the objective lens system, wherein said objective lens system is able to provide an infinity beam to the focusable telescope optical system and said focusable telescope optical system is able to receive said infinity beam and impart focal change to the front conjugate and rear conjugate of the objective lens system. In one embodiment, the common moveable or deformable rear lens system is a common moveable rear lens system. In another embodiment, the common moveable or deformable rear lens system is a deformable lens system. In one embodiment, the focusable telescope optical system comprises an afocal variator comprising a first positive lens system, a central negative lens system, and a second positive lens system, wherein the central negative lens system is positioned between the first and second positive lens systems and is able to move towards and away from the first positive lens system and towards and away from the second positive lens system. In another embodiment, the focusable telescope optical system comprises an afocal variator comprising a first positive lens system, a central negative lens system, and a second positive lens system, wherein one or more of the central negative lens system, first positive lens system, and second positive lens system are deformable.

In one embodiment, the present invention provides a microscope comprising: a) an optical housing able to hold one or more optical lens systems; b) an objective lens system disposed within the optical housing having a front conjugate and a rear conjugate, wherein said objective lens system comprises a semi-objective lens system and a common moveable or deformable rear lens system, wherein one or more lenses of said common moveable or deformable rear lens system is able to be deformed or moved towards and away from the semi-objective lens system so as to impart focal change to the front conjugate of the objective lens system; and c) a focusable telescope optical system in optical series with the objective lens system, wherein said focusable telescope system comprises an afocal variator comprising a first positive lens system, a central negative lens system, and a second positive lens system, wherein the central negative lens system is positioned between the first and second positive lens systems and is able to move towards and away from the first positive lens system and towards and away from the second positive lens system, and wherein said objective lens system is able to provide an infinity beam to the focusable telescope optical system and said focusable telescope optical system is able to receive said infinity beam and impart focal change to the front conjugate and rear conjugate of the objective lens system. In one embodiment, the common moveable or deformable rear lens system is a common moveable rear lens system. In another embodiment, the common moveable or deformable rear lens system is a deformable lens system.

One embodiment of the invention provides a method of correcting spherical aberration in a microscope comprising the steps of: a) providing a microscope comprising:
i) an optical housing able to hold one or more optical lens systems;
ii) ii) an objective lens system having a front conjugate and a rear conjugate, wherein said objective lens system is disposed within the optical housing and comprises a semi-objective lens system and a common moveable or deformable rear lens system; and
iii) iii) a focusable telescope optical system in optical series with the objective lens system; wherein one or more lenses of said common moveable or deformable rear lens system is able to be deformed or move towards and away from the semi-objective lens system so as to impart focal change to the front conjugate of the objective lens system, and wherein said objective lens system is able to provide an infinity beam to the focusable telescope optical system and said focusable telescope optical system is able to receive said infinity beam and impart focal change to the front conjugate and rear conjugate of the objective lens system; and
b) deforming or moving the position of the one or more lenses of said common moveable or deformable rear lens system in conjunction with adjusting the focus of the telescope optical system to provide a desired image of an object. The microscope optionally comprises a controller having a computer processor, wherein the controller is able to operate a means for repositioning the one or more lenses of the common moveable or deformable rear lens system and a means for focusing the focusable telescope optical system according to a software program or algorithm stored on the processor. A further embodiment comprises the additional steps of taking multiple scans at varying depths through the object, adjusting the focus of the telescope optical system and deforming or moving the position of the one or more lenses of the common moveable or deformable rear lens system during the multiple scans, analyzing images of the object from the scans, and determining optimal settings for the telescope optical system and common moveable or deformable rear lens system according to the software program or algorithm. Information from the multiple scans useful for determining the optimal settings include, but are not limited to, evaluating contrast, brightness, or intensity, in or more portions of the image.

In another aspect of the present invention, a microscope is provided comprising a dynamic objective activation system and a dynamic focusing system. In one aspect of the invention, the dynamic objective activation system acts primarily on the anterior Gauss particular (or the front conjugate) of a microscope objective, while the dynamic focusing system acts on both the anterior and posterior Gauss particulars (or the front and rear conjugates) of the microscope objective. The prior art does not teach the simultaneous juxtaposed use of such differently Gauss-weighted optical systems in conjunction with one another to provide spherical and other aberrational corrections.

The two systems are dynamic in that they both contain moveable lens elements able to be repositioned manually or by automated means in order to adjust the properties of the image. In one embodiment, the moveable lens elements in each system can be repositioned independently from one another. Preferably the moveable lens elements in both systems are moved in conjunction with one another to provide reduced or optimal spherical correction. This may mean that the lens elements are moved the same or different distances or that the lens element in one system is moved in the same direction or in the opposite direction as the lens element in the other system.

One embodiment of the present invention thus provides a microscope comprising: a) a dynamic objective activation system comprising a semi-objective lens system and a common moveable or deformable rear lens system, wherein the semi-objective lens system and common moveable or deformable rear lens system together form a functional microscope objective having an anterior Gauss particular and a posterior Gauss particular, and wherein the common moveable or deformable rear lens system is able to move towards and away from the semi-objective lens system so as to impart focal change to the anterior Gauss particular of the microscope objective; and b) a dynamic focusing system in optical series with the dynamic objective activation system, wherein the dynamic focusing system comprises a telescopic optical system and imparts focal change to both the anterior and posterior Gauss particulars of the microscope objective. In one embodiment, the common moveable or deformable rear lens system is a common moveable rear lens system. In another embodiment, the common moveable or deformable rear lens system is a deformable lens system.

Preferably, the dynamic focusing system comprises but is not limited to being an afocal variator or a subsumed afocal variator. In one embodiment, the dynamic focusing system comprises an afocal variator comprising a first positive lens system, a central negative lens system, and a second positive lens system, wherein the central negative lens system is positioned between the first and second positive lens systems and is able to move towards and away from the first positive lens system and towards and away from the second positive lens system. Alternatively, the dynamic focusing system comprises a first negative lens system, a central positive lens system, and a second negative lens system, wherein the central positive lens system is positioned between the first and second negative lens systems. In another embodiment, the dynamic focusing system comprises an afocal variator comprising a first positive lens system, a central negative lens system, and a second positive lens system, wherein one or more of the central negative lens system, first positive lens system, and second positive lens system are deformable.

In another embodiment, the present invention comprises a front positive optical lens system comprising a semi-objective and common moveable or deformable rear lens system and another optical system in which a moveable element or elements are positioned in front of a further rear subsumed or total afocal variator optical system, such systems each and independently capable of being utilized with the front optical system and providing independent or individually selectable focusing and spherical aberration correction potentials for distant as well as intermediate and near-focus ranges. The rear system notably operating on both the front and rear conjugates (anterior and posterior Gauss particulars) primarily providing optical focusing functions and the front system notably primarily operating on the front conjugate (anterior Gauss particular) primarily providing aberrational correction, both being able to juxtapose their functions in order to focus microscopes and other optical devices and to alter or correct spherical and other optical aberrations and artifacts in so doing.

In another embodiment, the present invention provides a method for manufacturing microscope systems by providing individual components and sub-assemblies so that the system can be provided modularly depending on the unique needs and specifications of the user. Because the objective of the present invention generates and provides an infinity beam to the focusable telescope optical system, a wide variety of telescopic focusing systems or optical components, including motorized focusing systems and components, that can function to receive or operate with an infinity beam can be used, just as any fixed focus telescope set at infinity can be used with present-day infinity-corrected microscope objectives currently produced that do not impart or act as a part of, an active microscope system.

Moreover, the moveable or deformable rear lens system can be made to be common to a series of specialized semi-objectives designed to produce an infinity beam when used in conjunction with the common moveable or deformable rear lens system. Additionally, the same motorized means for adjusting the positon of the common moveable or deformable rear lens system of the device can be used when different semi-objectives are used. The present invention does not require a separate motor to be used with each new semi-objective.

By utilizing a common moveable or deformable rear lens system in conjunction with the specifically designed semi-objectives, the production of microscopes is made more efficient and economical. A series of semi-objectives computed for use with a single common moveable or deformable rear lens system which is active, thereby turns every so-completed total objective of the series into a motorized correction collared equivalent. Thus, single correction collared objectives need not be produced which, by themselves, must incorporate costly mechanics and/or motors or other activating devices. Such a series of semi-objectives with moveable common moveable or deformable rear lens system being proprietary, the manufacture of microscopes is simplified in terms of offerings, techniques, and derivative microscopical methods. In addition, since modern microscopes generally utilize sensors to record images, the field coverage of some semi-objectives offered can be matched to the sensor needs, not the visual eyepiece requirements. This would lower cost significantly without sacrificing performance at the sensor.

One embodiment of the present invention provides focusing control by optical means to infinity-corrected compound or compounded microscopes. Preferably, the present invention provides optical focusing into volumes with spherical correction for each depth.

It is another object of the present invention to provide among other things, spherical correction and focusing of microscopes from a fixed (once determined) objective working distance. Preferably, the present invention provides a total microscope system, composed of a semi-objective, common moveable or deformable rear negative lens system capable of providing an infinity beam, and an afocal variator of any kind which, de facto, acts as an infinity telescope. In addition to as taught in Margolis (U.S. Pat. Nos. 4,988,173; 5,452,133 and 7,869,139), a substantial portion of the magnification change can also be controlled by judicious use of the focal lengths and the height of the infinity beam of the system. In one embodiment, the total microscope system comprises a regular infinity objective incorporating a correction collar type device as is already known in the art, in conjunction with an afocal variator of any kind which, de facto, acts as an infinity telescope.

It is another object of the present invention to provide a system where a moving negative lens, acting as the final lens to a semi-objective and thus completing it to be a microscope objective in toto, is able to be activated manually or by all art known means, controlled or modified by logarithms and/or software with computation. It is another object of the present invention for the afocal variator/infinity lens to be used in juxtaposition with, and informationally iterating itself through known means in conjunction with the moving negative lens by all known possible computational means.

### BRIEF DESCRIPTION OF THE DRAWINGS

The accompanying drawings illustrate individual components of, or complete preferred embodiments of the present invention:

FIGS. 1A, 1B and 1C illustrate a microscope objective comprising a semi-objective and a common moveable or deformable rear lens system in one embodiment of the invention. As shown, the common moveable or deformable rear lens system as a whole can be moved toward and away from the semi-objective.

FIGS. 2A-2E illustrate different non-limiting embodiments of the common moveable or deformable rear lens system able to be used in the present invention provided that the selected combination of the semi-objective and common moveable or deformable rear lens system are calculated to form a functional microscope objective.

FIGS. 3A-3D illustrate afocal variators in certain embodiments of the invention. As shown in FIGS. 3A and 3B, the central negative lens system is positioned between the first and second positive lens systems and is able to move towards and away from the first and second positive lens systems. Alternatively, as shown in FIGS. 3C and 3D, one or more of lens systems of the afocal variator are deformable.

FIGS. 4A-4C illustrate a microscope in certain embodiments of the invention comprising an afocal variator as part of the telescopic focusing system as well as a microscope objective comprising a semi-objective and a common moveable or deformable rear lens.

FIG. 5 illustrates a microscope turret in one embodiment of the invention having multiple semi-objective tubes, where each semi-objective tube comprises a different semi-objective lens system. A common moveable or deformable rear lens system is positioned within the microscope stand. Rotating the turret allows each semi-objective tube to be selected and aligned with the common moveable or deformable rear lens system, wherein the common moveable or deformable rear lens system can be moved toward and away from the semi-objective in each instance as necessary.

FIG. 6 illustrates one embodiment of the invention where the semi-objective lens system and common moveable or deformable rear lens system can be provided to the microscope system as separate interchangeable modules. In this embodiment, a variety of different semi-objectives can be selected for use with a variety of different common moveable or deformable rear lenses and attached to the telescopic focusing system.

FIG. 7 illustrates one embodiment of the invention where multiple microscope semi-objective tubes are arranged around and even underneath an object. Each semi-objective tube is part of a microscope thereby allowing images from different perspectives to be taken of the same object at the same time, where the depth of focus for each microscope can be adjusted through the object. Additionally, the spherical aberration for each image can be drastically reduced as taught by the present invention.

FIGS. 8A and 8B illustrate a microscope objective comprising a semi-objective and a common moveable or deformable rear lens system in one embodiment of the invention where the common moveable or deformable rear lens is deformable.

FIGS. 9A, 9B and 9C illustrate a microscope objective comprising a semi-objective and a common moveable or deformable rear lens system in one embodiment of the invention. As shown, the common moveable or deformable rear lens system comprises multiple lens elements, where the outer lens elements can be moved toward and away from the central lens element.

FIGS. 10A and 10B illustrate a microscope objective comprising a semi-objective and a common moveable or deformable rear lens system having multiple lens elements in one embodiment of the invention, where the central lens element is deformable.

FIG. 11 illustrates a 25×0.65 NA semi-objective (such as generally described by Aklin in U.S. Pat. No. 3,514,189) used with a rear lens from a Bausch & Lomb microscope (such as generally described in U.S. Pat. Nos. 3,476,462; 3,507,554; 3,481,665). The semi-objective and rear lens are positioned according to a design from a Zemax® optical design program and computer analysis. The middle drawing shows the actual Bausch & Lomb fixed position for the rear lens for nominal results. The top drawing shows the rear lens positioned 2.5 mm closer to the last element of the semi-objective, which can correct for thick or highly refractive subjects and which also results in the rear lens nearly touching the last lens in the semi-objective. The bottom drawing shows the rear lens positioned 2.5 mm further away from the last element of the semi-objective, which can correct for thin or low refractive subjects.

FIG. 12 shows the effect the configurations of FIG. 11 have on the rear conjugate. If used with a correct standard preparation, such as a normal 0.17 mm cover slip, a correct infinity beam can be produced (the middle drawing). However, if the rear lens is moved −2.5 mm (top) or +2.5 mm (bottom), the infinity beam is compromised, diverging in the top configuration and converging in the bottom configuration.

FIG. 13 provides graphs depicting spherical aberration for the configurations of FIG. 11. These graphs illustrate the sensitivity caused by repositioning the rear lens by 2.5 mm. Even a small movement of 2.5 mm produces a significant spherical error that counterbalances the error introduced by the incorrect preparation. It should be noted that the movement is symmetrical or nearly so from the central nominal drawing.

FIG. 14 provides a graph showing the shift of the front focus in relation to moving the common moveable or deformable rear lens −0.2 mm and +0.2 mm in an embodiment of the present invention (also using a 25×0.65 NA semi-objective). The graphs indicate that moving the common rear lens 0.2 mm results in a front focal shift of only approximately 0.012 mm.

### DETAILED DESCRIPTION OF THE INVENTION

While microscope objective design has reached a point of great correction and superb imagery, it is believed that the configuration of microscope objectives has not reached its most effective potential. Only by utilizing semi-objectives and a moving or deformable common rear lens can the microscope be brought to a complete or near complete level of correction for almost all circumstances of use. Preferably, the semi-objectives and common moveable or deformable rear lens systems can be used with any focusable telescope focusing system. However, without the common moveable or deformable rear lens system and semi-objective construction, all objectives cannot be corrected within the bounds of a single solution or device. The inescapable conclusion derived from the present invention is that the evolution of microscope objective design has overlooked the fact that a common rear lens system is preferable for use with semi-objectives which then and only then become complete objectives when used with the common rear lens and that this common rear lens must have movement.

The present invention provides microscopes and optical devices with the ability to provide improved spherical aberration correction by combining aspects and certain characteristics of the correction collar and similar devices, which operate primarily on the front conjugate of the microscope objective, with different aspects and characteristics of active focusing in telescopic focusing systems such as afocal variators (subsumed or modular) that operate primarily on both the front and rear conjugates of the objective. Use of the two different Gauss-primacy devices (i.e., one system able to primarily act upon the anterior Gauss particular and the second system able to act upon both the anterior and posterior Gauss particulars) together in operation as taught herein, and driven by appropriate means of art-known activation and controlled by appropriate algorithms and software, permit a novel degree of optical excellence and spherical correction to be achieved. By such use of the two different Gauss-primacy devices, focusing from a fixed position into depths with concomitant maintenance of spherical correction can, for the first time, be obtained to a level of perfection heretofore unattained.

Modern microscopes are infinity corrected. Characteristically, an objective lens is set at its working distance from an object and its exit beam accordingly emerges at infinity. Then, a telescopic system set for infinity focus accepts this beam and focuses it to the image plane. Any infinity telescope positioned in the infinity beam of an infinity-corrected microscope will automatically bring an objective set at its working distance to focus. This holds true whenever there are no extraneous influences in front of the objective. However, particularly in biological and semi-conductor practice, cover glasses or optical flats must be used between the objective and subject. Further, mounting media and other aqueous or refractive liquids, are commonly used in front of the objective. A problem arises because these extraneous glasses, flats and media are optical systems in their own right and must be accounted for.

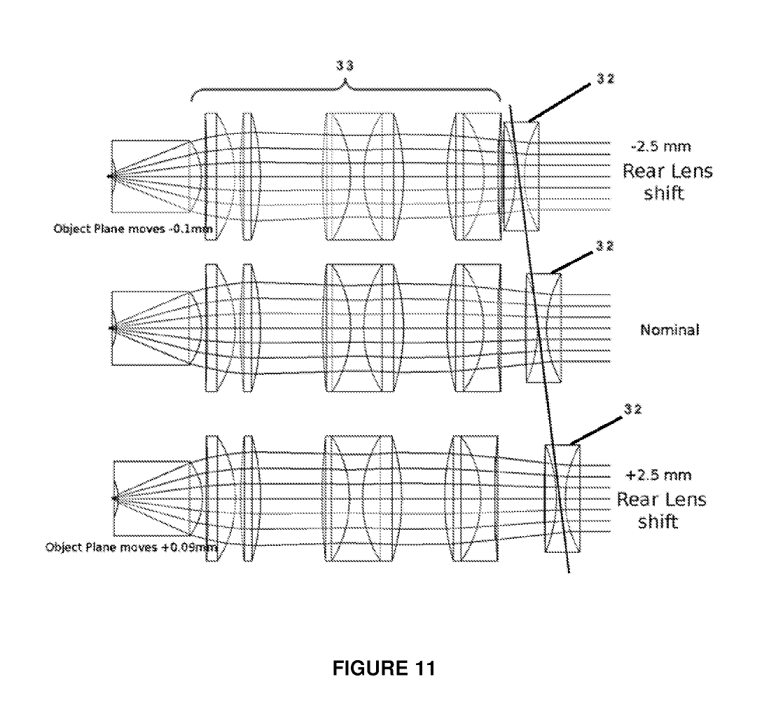

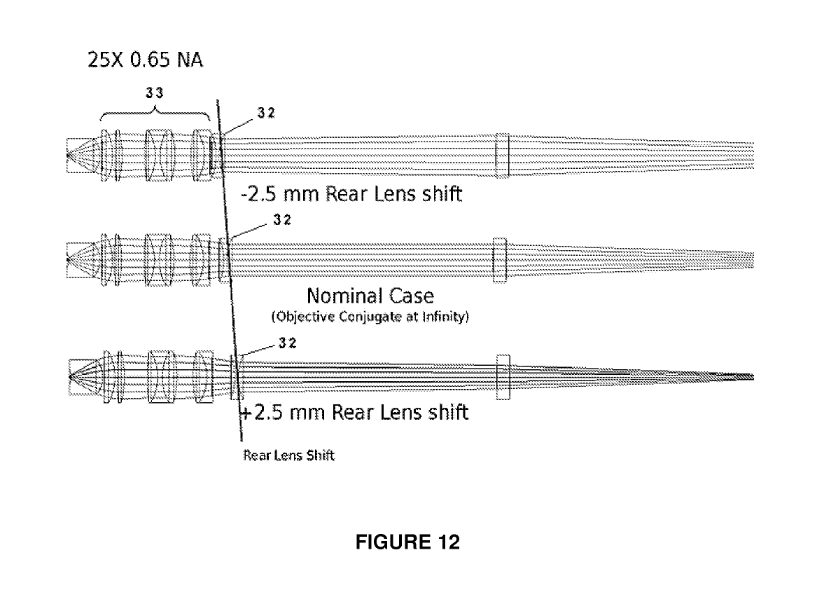

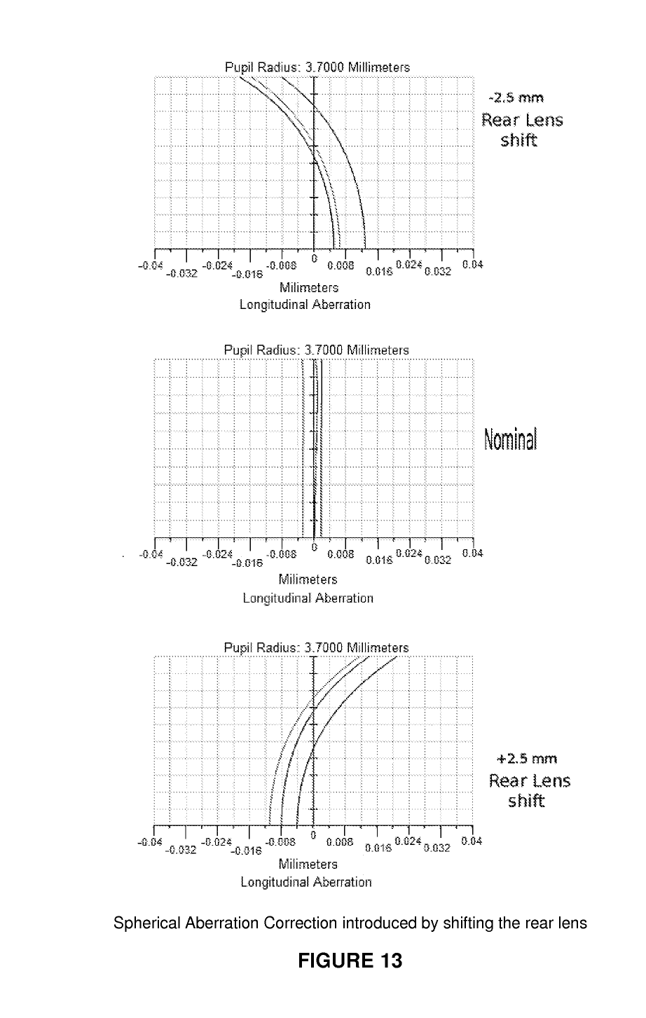

To solve this problem for a predictable ideal condition, microscope objectives—particularly of biological type—are most often set for use with 0.17 mm of cover slip/media thickness with the object directly underneath. Those used in the semiconductor industry may even be set for approximately 3.5 mm thickness. However, a new problem arises if the cover slip/media thickness deviates from the pre-set distance. For example, if an objective set for 0.17 mm is used with a 25×0.65 NA semi-objective (such as generally described by Aklin in U.S. Pat. No. 3,514,189) with a preparation that is either slightly thinner or thicker, then the optical path is altered considerably (see FIG. 11). In such case, spherical aberration occurs whereby the objective becomes incapable of focusing all rays to same plane. In an infinity-corrected microscope, this means that the objective is not presenting a proper infinity beam (for example, see FIG. 12). In order to focus the device, the position of the rear lens 32 must be shifted closer or further away from the semi-objective 33 which results in the system imagery being compromised. FIG. 13 shows the sensitivity caused by repositioning the rear lens 32 by 2.5 mm. Even a small movement of 2.5 mm produces a significant spherical error that counterbalances the error introduced by the incorrect preparation. This also demonstrates that as the NA (numerical aperture) gets higher, the system becomes more sensitive, with regard to spherical change and correction, to movement of the rear lens.

Additionally, positioning the rear lens 32 closer to the last element of the semi-objective 33 in this system by 2.5 mm (see the top figure of FIG. 11) will result in the rear lens nearly touching the last lens in the semi-objective. This close distance would not allow the use of a turret able to switch between different common rear lenses.

However, by way of example, if an infinity-corrected telescope equipped with either a modular or subsumed afocal variator, such as disclosed by Margolis (U.S. Pat. Nos. 4,988,173; 5,452,133 and 7,869,139) or containing one or more deformable lens systems, is placed in a non-infinity beam, the infinity condition can be compensated by the focusing action of the telescope.

The action of the afocal variator equipped telescope acts on the objective's front and rear conjugate. Its action is dynamic with respect to focusing and can provide substantial focal translation. When the focus is changed, the afocal variating telescope then necessitates a mechanical refocus of the objective at a new working distance that assumes all the deviances induced by the preparation. When the objective is then mechanically moved to that position to re-establish focus, it then presents an infinity beam to the telescope. The system is corrected as if it were an ideal preparation.

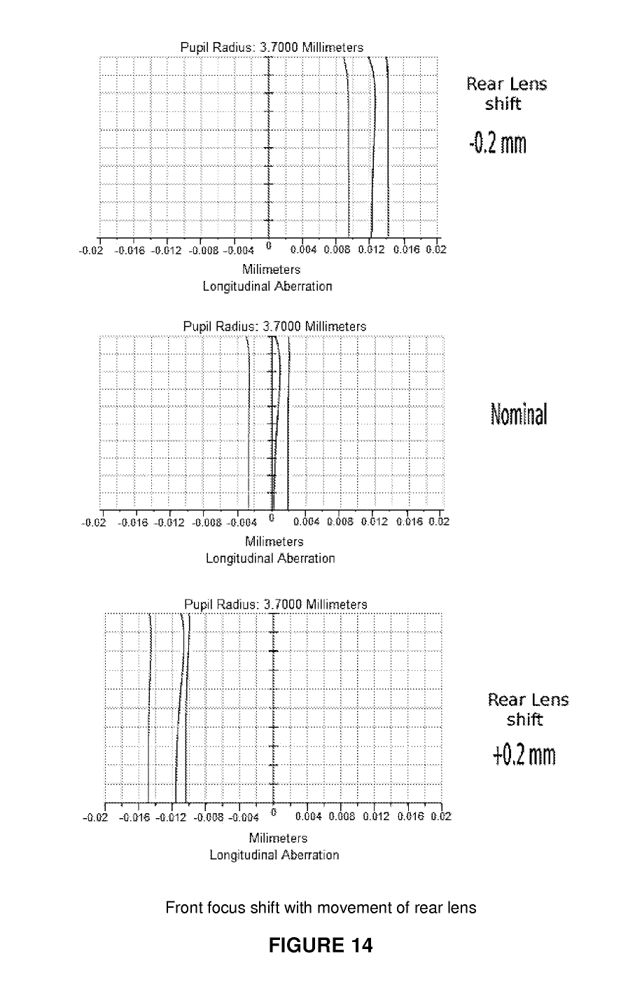

On the other hand, if a pre-set, fixed infinity telescope, incapable of focus is used with an objective equipped with what is known as a correction collar, whereby lens elements inside the objective can be moved and respaced, the objective can restore an infinity beam presentation to the fixed telescope and, with mechanical distance adjustment, the proper conditions are restored. It is also important to note that the action of the correction collar in moving the lenses of the objective itself produces hardly any focal translation with (especially) high numerical aperture objectives--the very ones most susceptible to being influenced by spherical errors. For example, FIG. 14 shows that moving the common rear lens 0.2 mm results in a front focal shift of only approximately 0.012 mm. This illustrates how little front focus is afforded by moving the common rear lens system. As a focusing means, the common moveable or deformable rear lens system would not be effective, whereas an afocal variator as part of the telescopic focusing system would be able to afford focus. Thus, this establishes the need for two systems in the present invention in order to be dynamic.

The dynamic focus obtained from the afocal variating telescope can reasonably replicate the stability and constancy of magnification during focal translation, as taught by Margolis (U.S. Pat. Nos. 4,988,173; 5,452,133 and 7,869,139). Consequently, if this type of telescopic focusing system is used per the means of the present invention with objectives equipped with correction collars, the combination of both systems can be used to establish greater spherical correction in addition to dynamic optical focal translation.

In and by itself, the focal translation of the afocal variating telescope provides a way to sweep the image (focus) planes without requiring physical movement of the objective and while introducing spherical aberration that is acceptable for many applications (Kam et al., 1997, Bioimaging 5:40-49). However, the afocal variating telescope alone will not be sufficient to correct spherical aberrations at progressive depths without a compromised result to some extent. The afocal variating telescope alone can, of course, be used to correct spherical errors, but only when the objective is mechanically moved to a new reciprocal working distance. In contrast, the present invention allows dynamic optical focal translation without moving the objective and enables increased spherical correction at all depths.

Now taught is the means by which dynamic optical focal translation can be performed into volumes or into media and cover glass variations without movement of the objective, yet with full spherical compensation at each successive depth. To accomplish this, not one, but two corrective devices must be mated and, ultimately juxtaposed in their function. In this way, virtually all microscopical circumstances where spherical correction is necessitated can be fulfilled by means of the present invention.

These and other objects of the present invention will become apparent to those skilled in the art from the descriptions provided herein, showing the contemplated novel construction, combination of elements as herein described, and, more particularly defined by the appended claims, it being understood that changes in the precise embodiments of the herein disclosed invention are meant to be included as coming within the claims, insofar as they may be precluded by the prior art.

### EXAMPLES

Microscopes are so-called “mature products,” well-defined in concept, structure and execution. For example, a typical biological laboratory microscope almost invariably is equipped with four or five objectives, generally, a scanner (c. 2.5-5×), low (c.10×), medium (c.20×), high-dry (40×) and immersion high 100×, an Abbe-type condenser, a mechanical stage, an observation tube (usually binocular or trinocular), eyepieces (usually 10×), a port or ports for camera or sensors and built in illumination (preferably of the Koehler type). Research microscopes have more diversity of concept, structure and execution, but still are “mature products” in that they share common construction designs.

The use of correction collars is equally well-standardized. Objectives below 0.65NA are virtually never equipped with correction collars, since all but the most extreme cover/preparation deviations affect their performance. It is even rare to find 0.65 NA objectives equipped with a correction collars since they generally tolerate a 0.03 mm +/− deviation from the 0.17 mm standard for biological objectives. The characteristics of the moveable common rear lens exactly conform to this. As noted herein, because the common rear lens operates primarily on the front conjugate, its principle use is for spherical and other aberrational control and not as a significant optical focusing device. Consequently, when articulated in conjunction with low power/low NA objectives which do not need it, focus is obtained—but with wild extremes in magnification and aberrational errors. With 0.65 and higher NAs, the action of the moveable common rear lens requires progressively less movement to affect aberrational correction and less and less effect on focus is observed. In short, the moveable common rear lens is advantageous for exactly the same conditions and practices as those objectives equipped with correction collars. The “mature nature” of microscope usage and specification is maintained; it is now simply open to being further refined and redefined.

It is an object of the present invention to redefine the microscope as such a “mature product” by providing a new set of features and performance levels. The present invention entails a new way to provide higher-quality imagery at potentially lower cost of production. The present invention also combines virtually all aspects and means for spherical and other optical aberration corrections in a novel way at potentially lower cost of production. By using larger lens elements with less curved surfaces, the present invention also provides potentially higher-quality imagery at potentially lower costs. In sum, the present invention changes the parameters and assumptions for the design and manufacture in serial production as has heretofore been entertained by producers of such products.

### Example 1

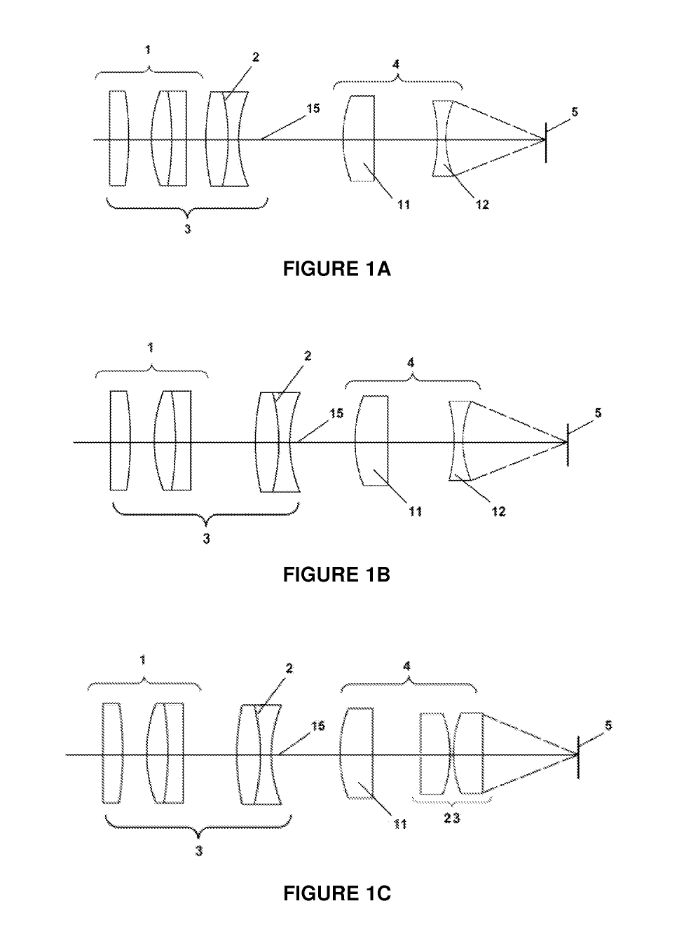

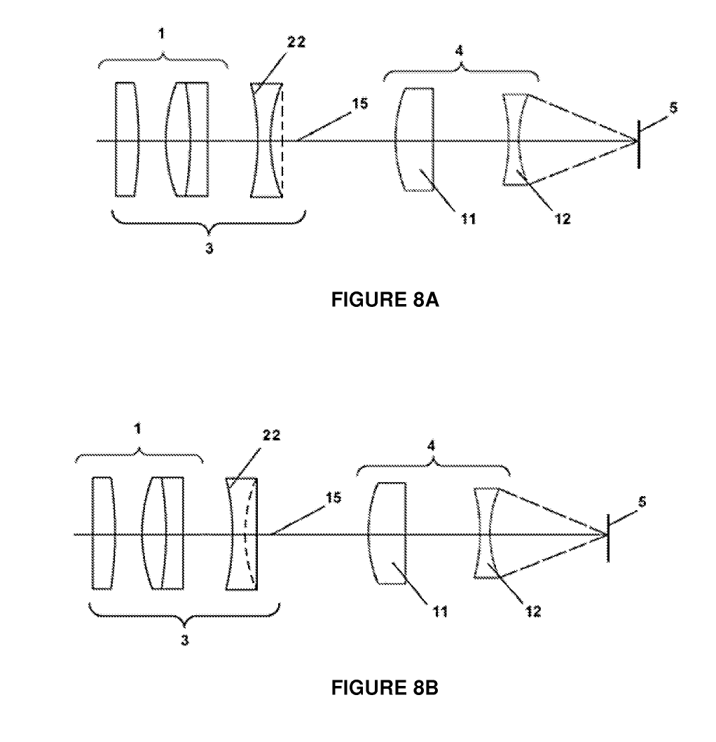

FIGS. 1A, 1B and 1C show a microscope objective 3 in one embodiment of the invention comprising a semi-objective lens system 1 and a common moveable or deformable rear lens system 2. As illustrated in these figures, the common moveable or deformable rear lens system 2 can be continuously moved toward (FIG. 1A) and away (FIG. 1B) from the semi-objective lens system 1. Alternatively, the common moveable or deformable rear lens system comprises a deformable lens 22 (FIGS. 8A and 8B) where the shape or physical contours of the lens 22 can be adjusted or moved (as indicated by the dotted line). Deforming the lens 22 changes the focal length of the common moveable or deformable rear lens system as a whole. The formed objective 3 is able to produce an infinity beam, or a beam at near-infinity, to the subsequent optical components.

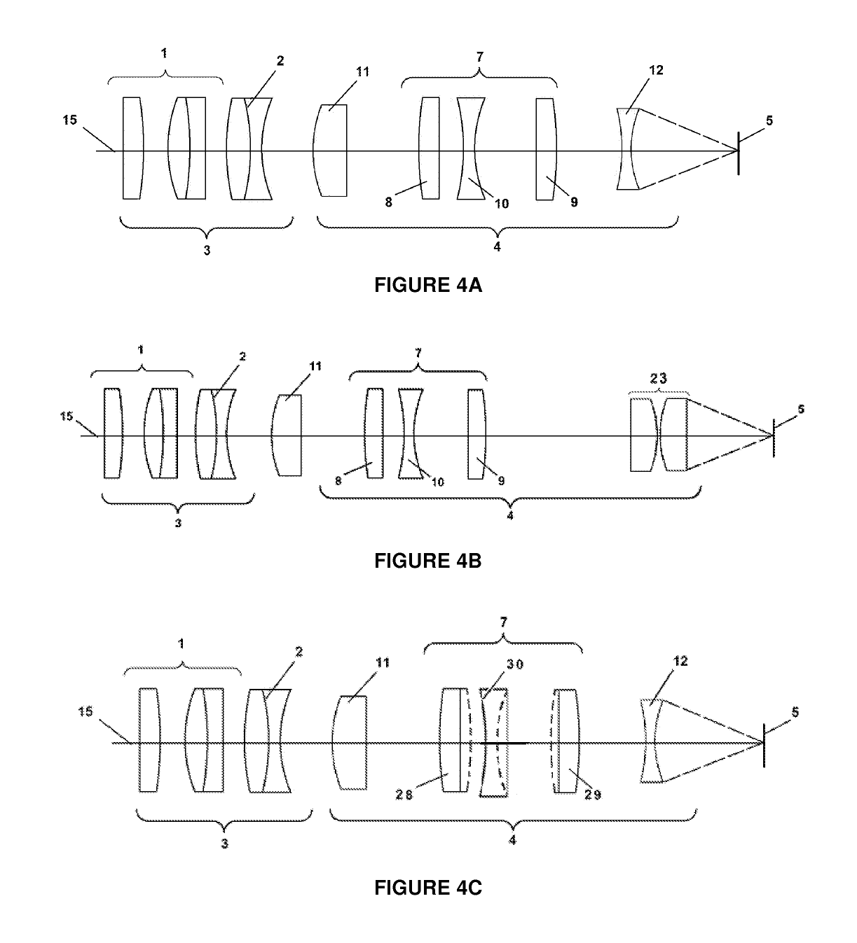

The objective 3 is placed along an optical axis 15 and in optical series with a focusable telescope optical system 4, which is then able to receive the infinity beam, or near infinity beam, to produce an image at the focal plane 5 of the device. While the preferred embodiment of the present invention utilizes an afocal variator as part of the focusable telescope optical system 4 (see FIG. 4), the semi-objective 1 and common moveable or deformable rear lens system 2 as described herein can be used with conventional or simple telescope systems. The focusable telescope optical system 4 shown in FIGS. 1 A and 1B comprise a telescope lens 11 and amplifier lens 12. However, as shown in FIG. 1C, this can be supplemented by a standard eyepiece lens 23 or any other rear lens, sensor or camera compatible with the optical system, such as a Barlow lens or any other lens system used in microscopy.

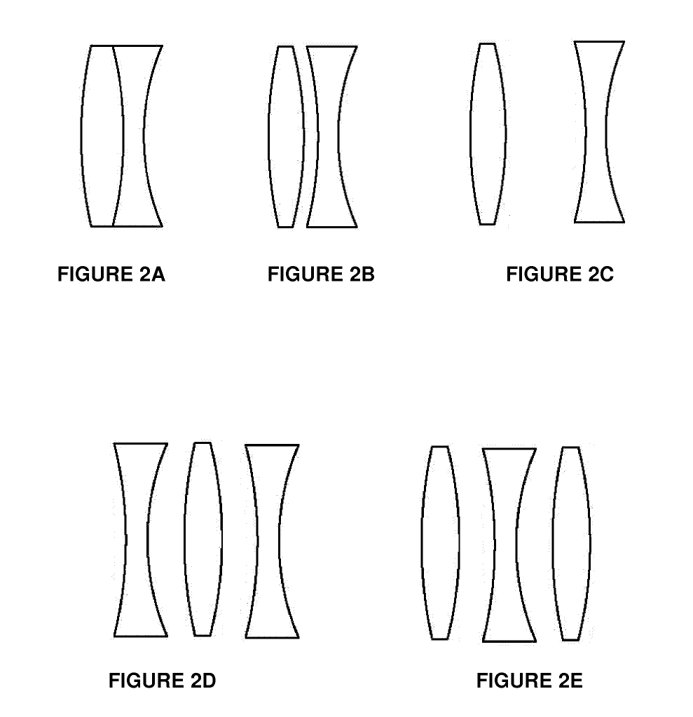

As is known in the art, the semi-objective lens system 1 can comprise a single lens or a combination of lenses, including but not limited to doublets as known in the art. Similarly, it is also understood that the common moveable or deformable rear lens system 2 can comprise a single lens or a combination of multiple lens elements as long as the combination of the semi-objective lens system 1 and common moveable or deformable rear lens system 2 are calculated to produce a functional microscope objective 3 as known in the art. FIGS. 2A-2E show different non-limiting embodiments of the common moveable or deformable rear lens system able to be used in the present invention. Preferably, the common moveable or deformable rear lens system has a net negative power. Where multiple lens elements are used to form the common moveable or deformable rear lens system, the distance between each lens element may be varied according to the desired effect and field coverage (see FIGS. 2B and 2C), even to the extent of incorporating an aperture diaphragm position. For example, the common moveable or deformable rear lens system can be positioned in such a way that an aperture diaphragm can be incorporated to allow for dark field objectives.

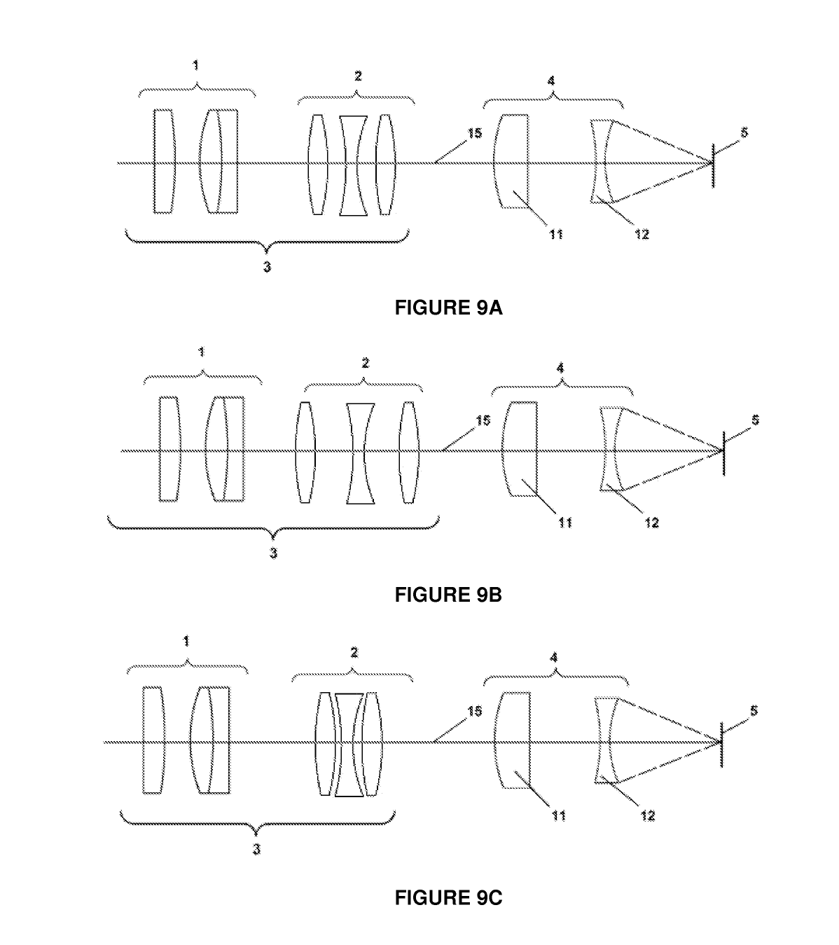

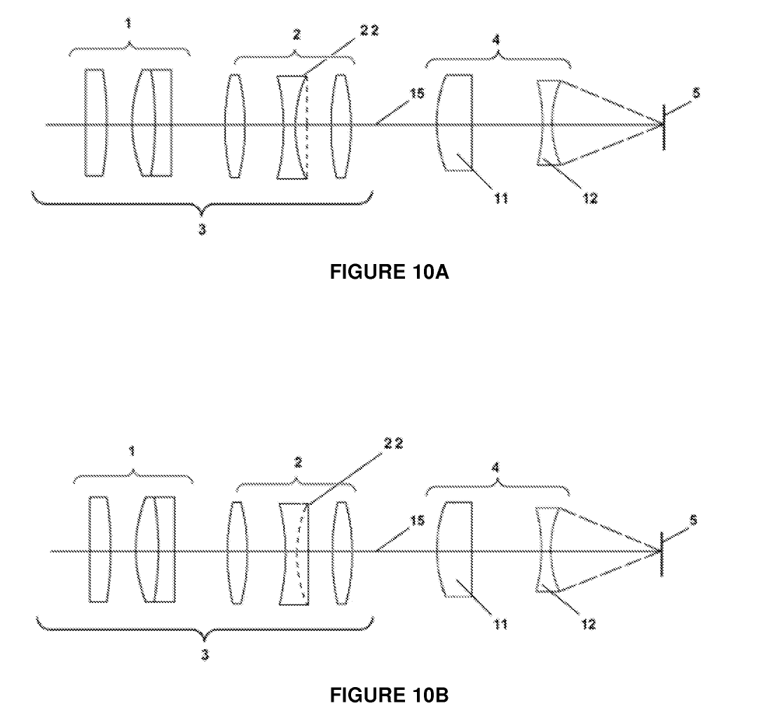

In one embodiment, each lens or lens element within the common moveable or deformable rear lens system are moveable and can be moved independently of one another or as a complete unit. Alternatively, one or more lenses or lens elements may be moveable while the other lenses or lens elements are fixed. As a non-limiting example, the common moveable or deformable rear lens system may comprise three lens elements where the rear lens system can be moved as a whole toward and away from the semi-objective lens system, or the different lens elements can be moved apart or closer together (see FIGS. 9A, 9B and 9C). Additionally, the outer lens elements may be fixed and the central lens element moved toward and away from the outer lens elements, the central lens element may be fixed and the outer lens elements moved toward or away from the central lens element, or the common moveable or deformable rear lens system may comprise any permutations of the above. Additionally, the common moveable or deformable rear lens system may comprise a deformable lens 22 (FIGS. 10A and 10B) where the shape or physical contours of the lens 22 can be adjusted or moved (as indicated by the dotted line). Deforming the lens 22 changes the focal length of the common moveable or deformable rear lens system and can be used as an alternative or in addition to moving the position of the one or more lens elements.

The mutual effect of spherical aberration/focus will differ not only by how the common rear lens is constructed, but also by how it is articulated—whether in its entirety or by a central element or elements moving towards or away from outer elements—or by a combined more complex action involving both articulating means.

In this way, common moveable or deformable rear lens systems can be of various types, selected for various advantageous characteristics and even be modular, so that the choice of one type of front or rear conjugate balance can be exchanged for another, permitting the mating, selection or even the combination of various modules to suit various potential techniques or applications.

### Example 2

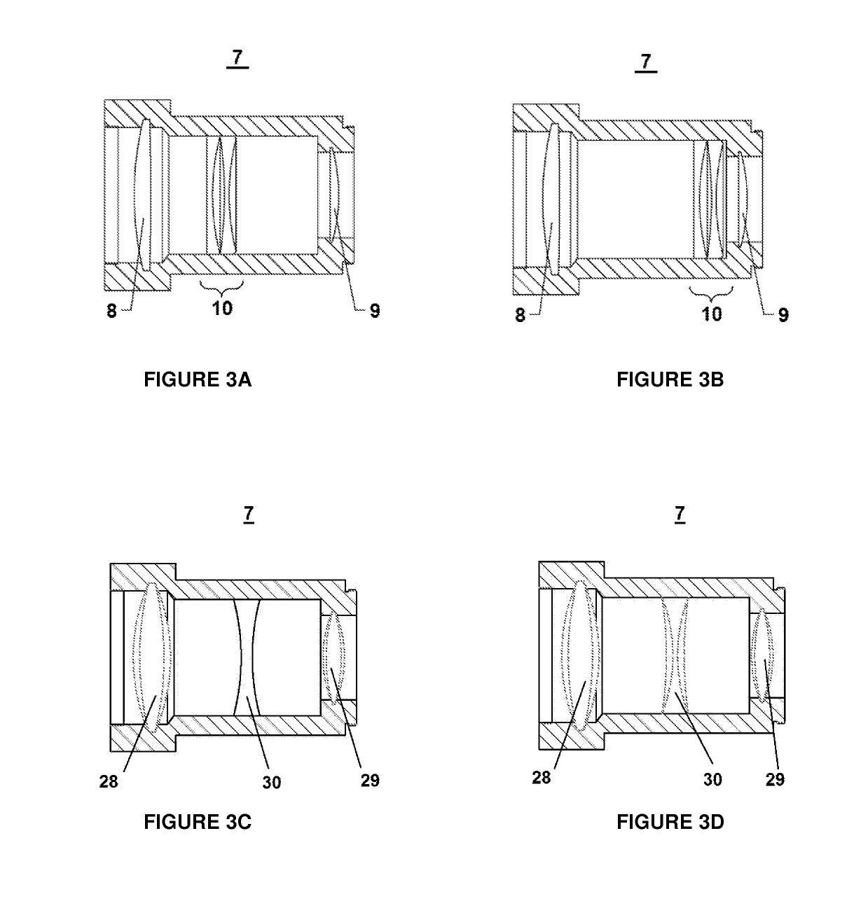

As discussed above, the use an afocal variating telescope in conjunction with a common moveable or deformable rear lens system provides a way to sweep focal planes of an image and correct spherical aberration without requiring physical movement of the objective. FIGS. 3A and 3B illustrate one type of afocal variator 7 as described in Margolis (U.S. Pat. No. 4,988,173). The afocal variator comprises a central negative lens system 10 positioned between the first positive lens system 8 and second positive lens system 9 and is able to move towards and away from the first and second positive lens systems. The exact position of the central negative lens system 10 between the first positive lens system 8 and second positive lens system 9 can be adjusted to achieve the desired focus.

FIGS. 3C and 3D illustrate another type of afocal variator 7 comprising a central negative lens system 30, which may be deformable (see FIG. 3D), positioned between a first deformable positive lens system 28 and a second deformable positive lens system 29. The shape or physical contours of lens systems 28, 29 and 30 can be adjusted (as indicated by the dotted lines) to achieve the desired focus. FIG. 3C shows an afocal variator with two “outboard” deformable positive lenses and a central fixed optical negative one. By transferring optical power from one outboard element to the other, variation is achieved. FIG. 3D shows an afocal variator with two “outboard” deformable positive lenses and a central deformable negative one. Here, variation is achieved when optical power is transferred from one outboard positive element “assisted” by deformation of the negative element in concert with it. In an alternative embodiment, the central negative lens system is deformable while the first and second positive lens systems are not deformable. The choice of afocal variation as the best known means of providing a telescope with plus/minus infinity focus is in part due to its ability to utilize large apertures. Single element deformable lenses are generally of small diameters so that they can be of low mass. Larger-aperture deformable systems are possible by utilizing afocal variator configurations such that their elements need not move as dramatically. The totality of the afocal variator itself provides a high degree of efficiency.

FIGS. 4A-4C each illustrate a microscope similar to that depicted in FIGS. 1A, 1B and 1C but which incorporates an afocal variator 7 (such as shown in FIGS. 3A-3D) as part of the focusable telescope optical system 4. In these embodiments, a semi-objective lens system 1 and a common moveable or deformable rear lens system 2 combine to form an objective 3 able to produce an infinity beam or near-infinity beam. The objective 3 is placed along an optical axis 15 and in optical series with a focusable telescope optical system 4, which is able to produce an image at the focal plane 5 of the device. The focusable telescope optical system 4 comprises a telescope lens 11, afocal variator 7, and eyepiece lens 12, where the central negative lens system 10 is able to move towards and away from the first positive lens system 8 and second positive lens system 9. Use of the afocal variator permits focus of the microscope device and correction of spherical aberration without changing the distance between the device and the sample. For example, the tube lens will not have to be moved closer to or away from the sample.

With regard to the embodiments shown in FIG. 4A and 4B, the central negative lens system 10 of the focusable telescope optical system 4 is activated along with the common moveable or deformable rear lens system 2 to focus on the desired object and provide a spherically corrected image. The central negative lens system 10 and common moveable or deformable rear lens system 2 can be repositioned or deformed independently to one another or at the same time with one another. The central negative lens system 10 and common moveable or deformable rear lens system 2 can also be repositioned or deformed manually or using mechanical or automated means as is commonly known in the art. A controller (not shown) connected to the mechanical or automated means for moving or deforming the central negative lens system 10 and common moveable or deformable rear lens system 2 contains a computer processor which determines the parameters of a desired image and moves or deforms the central negative lens system 10 and common moveable or deformable rear lens system 2 accordingly.

Alternatively, with regard to the embodiment shown in FIG. 4C, one or more of the deformable lenses 28, 29 and 30 are deformed in conjunction with the activation of the common moveable or deformable rear lens system 2 to focus on the desired object and provide a spherically corrected image. The one or more deformable lenses 28, 29 and 30 and common moveable or deformable rear lens system 2 can be repositioned or deformed independently to one another or at the same time with one another and can be repositioned or deformed manually or using mechanical or automated means as is commonly known in the art. A controller (not shown) connected to the mechanical or automated means for moving or deforming the one or more deformable lenses 28, 29 and 30 and common moveable or deformable rear lens system 2 contains a computer processor which determines the parameters of a desired image and moves or deforms the one or more deformable lenses 28, 29 and 30 and common moveable or deformable rear lens system 2 accordingly.

### Example 3

Because the common moveable or deformable rear lens system 2 can be used with different semi-objective lens systems 1 having varying properties, a microscope can be constructed where different objective lens systems 1 can be selected and incorporated into the device. For ease of changing the semi-objective lens system 1, the same common moveable or deformable rear lens system 2 can be built into the frame or stand of the microscope and different semi-objective lens systems attached to and removed from the microscope so as to be aligned with the common moveable or deformable rear lens system.

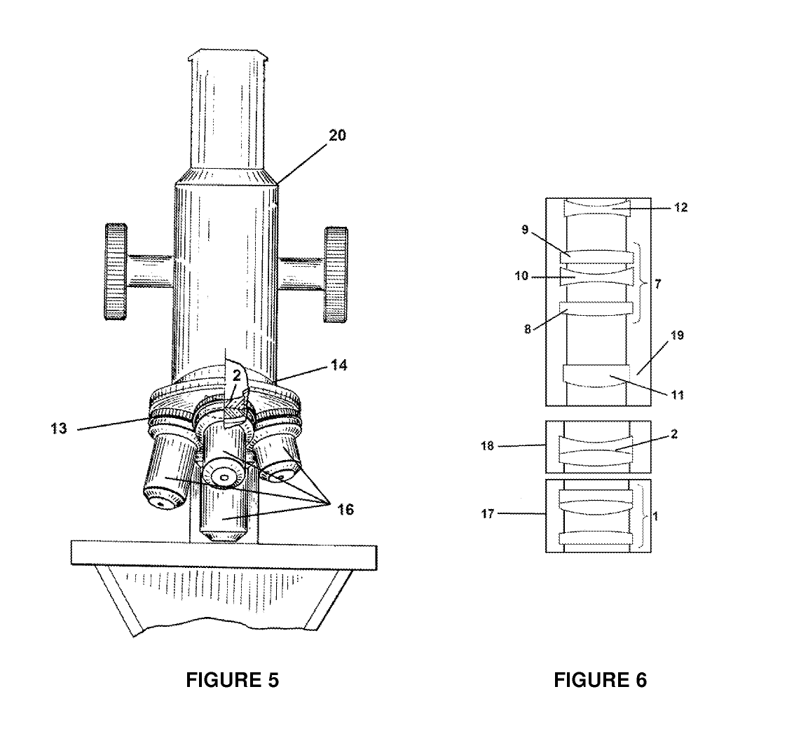

For example, FIG. 5 illustrates a common microscope 20 (similar to the microscope described in U.S. Pat. No. 3,481,665) having a turret 13. In this embodiment, the turret 13 contains multiple semi-objective tubes 16, where each semi-objective tube 16 comprises a different semi-objective lens system 1. A common moveable or deformable rear lens system 2 is positioned within the microscope stand 14. Rotating the turret 13 allows each semi-objective tube 16 to be selected and aligned with the common moveable or deformable rear lens system 2, wherein the common moveable or deformable rear lens system 2 retains the ability to be moved toward and away from the semi-objective 1 in each instance as necessary.

Such microscopes can contain a focusable telescope optical system 4 having an afocal variator 7 as described in FIG. 4. However, such microscopes can also contain a simpler focusable telescope optical system 4 such as shown in FIGS. 1A and 1B. Even in situations where an afocal variator is not used, this arrangement provides an improvement over conventional microscopes in that the semi-objective lens system can be easily selected and changed while allowing adjustment of the common moveable or deformable rear lens system.

Alternatively, semi-objective lens system 1 is provided as an interchangeable semi-objective module 17 which attaches to the housing 19 of the microscope stand or frame or the common moveable or deformable rear lens system (see FIG. 6). Furthermore, the common moveable or deformable rear lens system 2 is also optionally provided as part of an interchangeable common moveable or deformable rear lens module 18 able to attach and detach from the housing 19 of the microscope stand or frame which contains the focusable telescope optical system 4 as depicted in FIG. 4. In this way, a variety of different semi-objectives can be selected for use with a variety of different common moveable or deformable rear lenses and attached to the microscope device.

These arrangements allow for specialized or proprietary objectives where a specialized or proprietary common moveable or deformable rear lens is built into the microscope frame or stand while interchangeable semi-objective lens systems, each calculated to be compatible with the common moveable or deformable rear lens system, are provided separately. Thus, a wide range of optical properties and configurations are achievable for the same single base model microscope. For example, the common moveable or deformable rear lens system can incorporate an additional proprietary reciprocal color correction lens system which provides color correction or chromatic aberration correction when used with the appropriate reciprocal semi-objective lens system.

### Example 4

One example of the present invention comprises an optical system whereby a microscope is equipped not only with an objective containing a common moveable or deformable rear lens system, but with an afocal variating telescope as well. When activated by suitable means and controlled for the contrast obtained from a sensor, or other means for determining a suitable image, and using algorithms and software to determine this, an activated objective can be made to present an infinity beam while focal translation is concurrently made by the afocal variating telescope. The result is that for the first time, volumes can be examined correctly without moving the objective while a virtually ideal spherical correction is provided throughout.

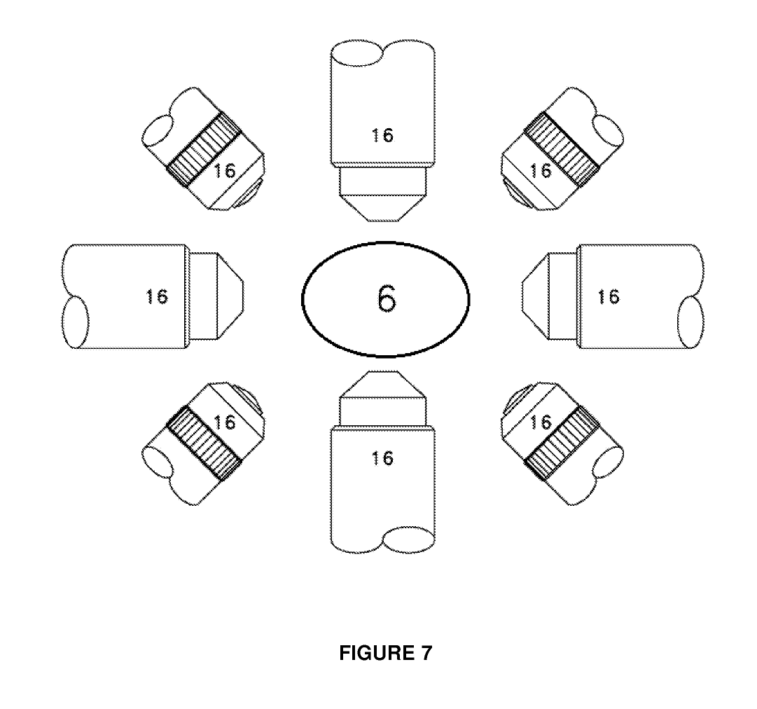

Moreover, delicate tissues or membranes in aqueous media would not be disturbed during the process of collecting images, since the objective would not move and, therefore, would not produce mechanically-induced compression. Multiple microscopes equipped as described herein could be positioned into volumes angularly or tangentially to the subject, all capturing imagery from different viewpoints, yet not disturbing the sample (see FIG. 7). Each semi-objective tube 16 is part of a microscope thereby allowing images from different perspectives to be taken of the same object 6 at the same time, where the depth of focus for each microscope can be adjusted through the object. The spherical aberration for each image can further be drastically reduced as taught by the present invention. Additionally, each semi-objective could be illuminated differently, be attached to a different microscope of any technique or type so that information could be obtained from various methods simultaneously, with the focus and aberrational correction being done without any disturbance to the specimen. It would also be possible to station microscopes in a protractor-like arc so that various planes can be examined and their images captured without necessitating movement of the mechanical focus. The present invention is not limited to just the protractor-like configuration shown in FIG. 7 and can be used with other proposed or actual microscopes with multiple objectives positioned above, below, or around a sample or specimen. For example, recently, the European Molecular Biology Laboratory established Luxendo GmbH to promote a “light-sheet microscope”. The present invention can be used with any known microscope type (such microscopes utilizing fluorescence illumination and structured illumination) and in any known configuration. Such microscopes can be constructed using the present invention; however, in and of itself, the present invention can be used in a protractor-like configuration for virtually any other type of microscopy as well. Further advantages of dynamic optical focal translation without objective movement will be appreciated by those already skilled in the arts and disciplines involved.

Motorized correction collared objectives such as, for example, the Leica motCORR™ objectives have been developed and commercialized. After the correction collar is activated, these objectives still require mechanical reset of focus, which involves moving the objective tube closer or away from the object. Also, the motCORR™ objectives are specifically high NA immersion types and are limited in use to being immersed in water for deep cell translations only; they are not designed for any other purpose. Even so, no correction collared objective has been used to the inventor's knowledge in concert with any kind of focusing telescope, especially like that as has been presented herein, to consistently present an infinity beam essentially at all times. Motorized correction collars are bulky and cannot be made to work easily on a turret or revolver so that successive objectives with motorized correction collars can be used for alternate purposes. In short, while it is possible to use standard motorized correction collared objectives in the way described herein in conjunction with afocal variating telescopes as described, it is not the optimal solution. Nevertheless, this configuration is claimed as a permutation of the present invention.

Preferably, any and all objectives on a microscope should be able to be set for their front conjugates by using one common means to do so. Earlier microscope designs (such as those described in U.S. Pat. Nos. 3,471,218; 3,476,462; 3,507,554; 3,481,665; 3,515,463; 3,514,189; and 3,174,396) propose using a semi-objective to be used with a fixed, stationary negative lens that acts as a 5× amplifier in concert with the semi-objective lens system. But none of these cited patents calls for the negative element to be actuated or moved—quite the contrary. Yet, if such semi-objectives are made with a negative element or elements that can move and be positioned separate from them, the whole device becomes substantially a total microscope system—not merely an aberrational corrective means but rather, an entirely novel infinity-corrected microscope in toto in which the moving negative lens acts as the lenses in correction collared objectives but in for all semi-objectives used with it while the afocal variating or other focusable telescope replaces the traditional fixed telescope lens. Moreover, the use of semi-objectives used in common with a moveable negative lens lowers cost because fewer optical elements are required in comparison with usual objective configurations. Increased light throughput and efficiency can also be expected

The system of the present invention can function as any microscope system extant—with the added benefit that it can provide dynamic focus with spherical correction at all times and under virtually all possible conditions encountered in microscopy regardless of technique or configuration. Therefore, there is no reason why the present system could not be included in all infinity-corrected microscopes—even to the extent of being used with Stimulated Transmission Emission Depletion (STED) and the like that have as of 2008 broken the diffraction barrier, since it does not disturb relationships but only improves upon configurational necessities. There is virtually no limit to its employment in any infinity-corrected microscope unless there are unexpected dimensional constraints. The entire system of the afocal variating telescope presented herein can easily fit into typical observation tubes, and the moving negative lens can easily fit into the area near the revolving turret or nosepiece and could also be positioned elsewhere. Any and all sensors, cameras, formats and optical components appropriately employed with infinity-corrected microscopes can be used with the present invention. Any and all algorithms developed or yet to be, that can be used with infinity-corrected microscopes are applicable for use with the present invention.

It is also now possible, under the teaching herein, to make objectives that have a very high degree of optical excellence which are designed for use with sensors. For example, in the 1980's there was a push to design the highest quality objectives for visual coverage at the eyepiece. A Field Number of 18 means that with a 10× objective and 10× eyepiece, a 1.8 mm field of view will be observed visually. Likewise, a Field Number of 26 means that that combination will achieve 2.6 mm field of view visually. Therefore, an objective with capabilities to go to 26 mm FOV Number will directly cover a photo film or sensor of 26 mm whereas, while an objective with 18 mm FOV Number will not cover a 26 mm film or sensor area; in fact, it will “porthole” or, in optical terms, vignette with a circular disc. But modern sensors used in microscopic devices typically only use 11 mm sensors as a standard format. Therefore, if a semi-objective for the present invention is made for, say 16 mm FOV instead of the more costly 26 mm FOV, it could perform equally on the sensor with the 26 mm FOV version, but all the extra optical components and complexity would not need to be incorporated. Thus, the present invention allows for the flexibility to easily substitute semi-objectives in situations where it would reduce cost or unnecessary complexity.

### Definitions

The terms and definitions contained herein are used according to their normal definitions as understood in the art. The following definitions are provided to add further clarification to the terms.

As used herein, the term “compound microscope” refers to a microscope of any kind which can form a real image by projection from a first objective system—as opposed to a simple microscope otherwise known as a magnifier, hand magnifier, desk magnifier, etc. which is used by itself directly in front of the eye that does not or cannot form or be made to form an intermediary or real image that permits the use of eyepieces, sensors or other optical components. Traditionally, “compound microscope” was defined a requiring an eyepiece but modern practice has made this restrictive definition obsolete.

As used herein, the term “lens system” can refer to a single lens or lens element, or to multiple lenses and lens elements, such as doublets or triplets, as known in the art. The term “focal plane” refers to the imaginary line perpendicular to the optical axis which passes through an optical system's focal point.

As used herein, the terms “moveable” and “moving” means that one or more lenses or lens elements of a lens system are articulable so as to be able to be moved along the optical axis. With regard to the common moveable or deformable rear lens, one or more lenses or lens elements of the common moveable or deformable rear lens system are able to be moved toward and away from the semi-objective lens system. With regard to a central negative lens system of an afocal variator, the central negative lens is able to be moved toward and away from the first and second positive lens systems.

As used herein, the term “deformable” means that the shape or physical contours of one or more lenses or lens elements can be adjusted so as to change the focal length or optical properties of the lens system as a whole.

“Chromatic aberration” is the lens aberration resulting from the normal increase in refractive index of all common materials toward the blue end of the spectrum. The change in image size from one color to another is known at lateral chromatic difference of magnification. While the present invention is described as providing improved spherical aberration correction, it is believed the present invention can also provide improved chromatic aberration correction in some embodiments.

As used herein, the term “infinity beam” refers to rays of light traveling in a parallel, or essentially parallel, path. As used herein, an “infinity beam” includes rays of light, or other types of electromagnetic radiation, travelling in a path which does not deviate by more than 5%, preferably no more than 1%, even more preferably no more than 0.1% from parallel.

As used herein, “infinity focus”, “set to infinity” or being able to form a “focus to infinity” is the state where a lens or other optical system is able to receive an infinity beam and form an image of an object.

As used herein, the terms “infinity-corrected” and “infinity correction” mean that beams or rays of light or other electromagnetic radiation are made to travel in essentially straight and parallel paths that do not deviate by more than 5%, preferably no more than 1%, even more preferably no more than 0.1% from parallel. Optical components that are infinity-corrected refer to components that are designed to receive, transmit, or be used in conjunction with beams or rays of light or other electromagnetic radiation traveling in straight and parallel paths, or essentially straight and parallel paths. “Infinity-corrected space” refers to the region or regions where infinity-corrected or essentially infinity-corrected beams are transmitted through the optical system.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without resort to undue experimentation without affecting the scope of the invention or any specific embodiment thereof, and that such modifications or changes are intended to be encompassed within the scope of the appended claims. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

All references cited herein are hereby incorporated by reference in their entirety to the extent that there is no inconsistency with the disclosure of this specification. All headings used herein are for convenience only. All patents and publications mentioned in the specification are indicative of the levels of skill of those skilled in the art to which the invention pertains, and are herein incorporated by reference to the same extent as if each individual publication, patent or patent application was specifically and individually indicated to be incorporated by reference. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

1-27. (canceled)

28. A microscope comprising:
a) an optical housing able to hold one or more optical lens systems;
b) an objective lens system disposed within the optical housing having a front conjugate and a rear conjugate, wherein said objective lens system comprises a semi-objective lens system and a common moveable or deformable rear lens system, wherein one or more lenses of said common moveable or deformable rear lens system is able to be deformed or moved towards and away from the semi-objective lens system so as to impart focal change to the front conjugate of the objective lens system; and
c) a focusable telescope optical system in optical series with the objective lens system, wherein said objective lens system is able to provide an infinity beam to the focusable telescope optical system and said focusable telescope optical system is able to receive said infinity beam and impart focal change to the front conjugate and rear conjugate of the objective lens system.

29. The microscope of claim 28 wherein the focusable telescope optical system comprises an afocal variator comprising a first positive lens system, a central negative lens system, and a second positive lens system, wherein the central negative lens system is positioned between the first and second positive lens systems and is able to move towards and away from the first positive lens system and towards and away from the second positive lens system.

30. The microscope of claim 28 wherein the focusable telescope optical system comprises an afocal variator comprising a first positive lens system, a central negative lens system, and a second positive lens system, wherein one or more of the central negative lens system, first positive lens system, and second positive lens system are deformable.

31. The microscope of claim 28 wherein the focusable telescope optical system comprises a first negative lens system, a central positive lens system, and a second negative lens system, wherein the central positive lens system is positioned between the first and second negative lens systems.

32. The microscope of claim 28 wherein the semi-objective lens system comprises at least one positive lens system, an apochromatic lens system, or both.

33. The microscope of claim 28 wherein the common moveable or deformable rear lens system is a negative lens able to move towards and away from the semi-objective lens system, a deformable lens, or comprises multiple lens elements where one or more of the lens elements are deformable, or are able to move towards and away from the semi-objective lens system.

34. The microscope of claim 28 comprising a plurality of selectable semi-objective lens systems, wherein each selectable semi-objective lens system has a different magnification and is able to form a functional microscope objective with the common moveable or deformable rear lens system.

35. The microscope of claim 34 comprising a turret having a plurality of objective tubes, wherein each objective tube contains a selectable semi-objective lens system, and wherein the turret is able to be rotated so as to selectably align one of the selectable semi-objective systems with the common moveable or deformable rear lens system.

36. The microscope of claim 28 wherein the one or more lenses of the common moveable or deformable rear lens system is repositioned or deformed manually and the focusable telescope optical system is focused manually.

37. The microscope of claim 28 further comprising a means for moving the one or more lenses of said common moveable or deformable rear lens system and means for focusing the focusable telescope optical system.

38. The microscope of claim 37 wherein the means for moving the one or more lenses of said common moveable or deformable rear lens system is a first motor and the means for focusing the focusable telescope optical system is a second motor.

39. The microscope of claim 37 further comprising a controller having a computer processor, wherein said controller is able to operate said means for repositioning the one or more lenses of said common moveable or deformable rear lens system and said means for focusing the focusable telescope optical system according to a software program or algorithm stored on said processor, wherein said controller moves the one or more lenses of said common moveable or deformable rear lens system in conjunction with focusing the focusable telescope optical system to provide a desired image according to parameters determined by said software program or algorithm.

40. The microscope of claim 39 further comprising a sensor able to detect contrast levels in an image generated by said microscope, wherein said controller is able to adjust the focus of the focusable telescope optical system and move the one or more lenses of said common moveable or deformable rear lens system in conjunction with focusing the focusable telescope optical system to provide a desired image with contrast determined by said software program or algorithm.

41. A method of correcting spherical aberration comprising the steps of:
a) providing a microscope comprising:
i) an optical housing able to hold one or more optical lens systems;
ii) an objective lens system having a front conjugate and a rear conjugate, wherein said objective lens system is disposed within the optical housing and comprises a semi-objective lens system and a common moveable or deformable rear lens system; and
iii) a focusable telescope optical system in optical series with the objective lens system;
wherein one or more lenses of said common moveable or deformable rear lens system is able to be deformed or move towards and away from the semi-objective lens system so as to impart focal change to the front conjugate of the objective lens system, and wherein said objective lens system is able to provide an infinity beam to the focusable telescope optical system and said focusable telescope optical system is able to receive said infinity beam and impart focal change to the front conjugate and rear conjugate of the objective lens system; and
b) deforming or moving the position of the one or more lenses of said common moveable or deformable rear lens system in conjunction with adjusting the focus of the telescope optical system to provide a desired image of an object.

42. The method of claim 41 wherein the microscope comprises a controller having a computer processor, wherein said controller is able to operate a means for repositioning the one or more lenses of said common moveable or deformable rear lens system and a means for focusing the focusable telescope optical system according to a software program or algorithm stored on said processor.

43. The method of claim 42 further comprising the steps of taking multiple scans at varying depths through the object, adjusting the focus of the telescope optical system and deforming or moving the position of the one or more lenses of said common moveable or deformable rear lens system during said multiple scans, analyzing images of the object from said scans, and determining optimal settings for the telescope optical system and common moveable or deformable rear lens system according to the software program or algorithm.

44. A microscope comprising:
a) a dynamic objective activation system comprising a semi-objective lens system and a common moveable or deformable rear lens system, wherein the semi-objective lens system and common moveable or deformable rear lens system together form a functional microscope objective having an anterior and posterior Gauss particular, and wherein one or more lenses of said common moveable or deformable rear lens system is able to be deformed or move towards and away from the semi-objective lens system so as to impart focal change to the anterior Gauss particular; and
b) a dynamic focusing system in optical series with the dynamic objective activation system, wherein the dynamic focusing system comprises a telescopic optical system and imparts focal change to both the anterior and posterior Gauss particular of the microscope objective.

45. The microscope of claim 44 further comprising a plurality of selectable semi-objective lens systems, wherein each selectable semi-objective lens system has a different magnification and is able to form a functional microscope objective with the common moveable or deformable rear lens system, and comprising a turret having a plurality of objective tubes, wherein each objective tube contains a selectable semi-objective lens system, and wherein the turret is able to be rotated so as to selectably align one of the selectable semi-objective systems with the common moveable or deformable rear lens system.

46. The microscope of claim 44 wherein the dynamic focusing system comprises an afocal variator comprising a first positive lens system, a central negative lens system, and a second positive lens system, wherein one or more of the central negative lens system, first positive lens system, and second positive lens system are repositionable or deformable wherein repositioning or deforming one or lenses of the afocal variator impart focal change to both the anterior and posterior Gauss particulars of the microscope objective.

47. The microscope of claim 46 further comprising a controller having a computer processor, wherein said controller is able to operate means for repositioning or deforming the one or more lenses of said common moveable or deformable rear lens system and repositioning or deforming one or more of the central negative lens system, first positive lens system, and second positive lens system according to a software program or algorithm stored on said processor, wherein said controller repositions or deforms the one or more lenses of said common moveable or deformable rear lens system in conjunction with the afocal variator to provide a desired image according to parameters determined by said software program or algorithm.
